(19) United States
(12) Patent Application Publication
(10) Pub. No.: US 2026/0002632 A1
(43) Pub. Date: Jan. 1, 2026

(54) ANCHORING SYSTEM

(71) Applicant: Robern Inc., Bristol, PA (US)

(72) Inventors: James L. Stanley, Levittown, PA (US); Jonathan Carter, Hamilton, NJ (US)

(21) Appl. No.: 19/219,453

(22) Filed: May 27, 2025

Related U.S. Application Data
(60) Provisional application No. 63/664,602, filed on Jun. 26, 2024.

(51) Int. Cl. F16M 13/02

(52) U.S. Cl. CPC F16M 13/02

(57) ABSTRACT

An anchoring device includes a first component having a body and a coupling ring extending axially from the body, and a second component including a base having a cavity, the cavity configured to receive the coupling ring, coupling the first component and the second component. The first component and the second component are configured to rotate relative to one another between a first coupled arrangement in which the coupling ring is configured to be withdrawn from the cavity and a second coupled arrangement in which the coupling ring is locked within the cavity.

### CROSS-REFERENCE TO RELATED APPLICATION

This application claims priority benefit of Provisional Application No. 63/664,602 (Attorney Docket No. 010222-24006A) filed on Jun. 26, 2024, which is hereby incorporated by reference in its entirety.

### FIELD

The present disclosure relates generally to the field of anchoring systems. More specifically, the present disclosure relates to an anchoring system including multiple coupled arrangements.

### BACKGROUND

Generally, a variety of fasteners and devices are available to couple or mount an object to a surface. Different fasteners and/or devices may be used to permanently or removably couple or mount an object to a surface. Generally, devices for removably coupling or mounting an object to a surface include a single coupled arrangement and provide for de-coupling or removal of the object after a single manipulation (e.g., rotation, translation). Accordingly, there is a need for a device for more securely removably coupling or mounting an object to a surface.

### BRIEF DESCRIPTION OF THE DRAWINGS

Objects, features, and advantages of the present disclosure should become more apparent upon reading the following detailed description in conjunction with the drawing figures, in which:

FIG. 1 illustrates an anchoring device in accordance with one example of the present disclosure.

FIG. 2 illustrates a perspective view of a first component of the anchoring device of FIG. 1 in accordance with one example of the present disclosure.

FIG. 3 illustrates a cross-sectional view of the first component along section line A-A of FIG. 2 in accordance with one example of the present disclosure.

FIG. 4 illustrates a perspective view of a second component of the anchoring device of FIG. 1 in accordance with one example of the present disclosure.

FIG. 5 illustrates a cross-sectional view of the second component along section line B-B of FIG. 4 in accordance with one example of the present disclosure.

FIG. 6 illustrates an anchoring device in a first coupled arrangement in accordance with one example of the present disclosure.

FIG. 7 illustrates an anchoring device in a second coupled arrangement in accordance with one example of the present disclosure.

FIG. 8 illustrates an anchoring system in accordance with one example of the present disclosure.

FIG. 9 illustrates a configuration for coupling a mirror to a wall in accordance with one example of the present disclosure.

FIG. 10 illustrates a flow chart for coupling an object to a surface in accordance with one example of the present disclosure.

### DETAILED DESCRIPTION

Described herein are devices, systems, and methods for coupling two objects to one another. According to some examples, the devices, systems, and methods described herein may be used to mount an object to a wall or another surface. For example, the devices, systems, and methods described herein may be used to couple any of a mirror, a bathroom fixture (e.g., soap dispenser, paper towel dispenser, hand dryer, toilet paper dispenser, towel rack, or the like), a shelf, a cabinet (e.g., medicine cabinet, kitchen cabinet), a cupboard, a light fixture, a portrait or artwork (including a frame or other enclosing structure) or the like to a wall. According to other examples, the devices, systems, and methods described herein may be used to couple an object to another surface, such as a ceiling. The devices, systems, and methods described herein may be used to couple any two objects to one another.

An anchoring devices or system according to the present disclosure may include a first component (e.g., first interlocking component, male portion, insert) and a second component (e.g., second interlocking component, female portion, receiver, receptacle). According to the present disclosure, the first component may include a body and a coupling ring (e.g., ring) extending from the body and the second component may include a base having a cavity configured to receive the ring.

The first component and the second component may be rotatably coupled to one another and configured to rotate relative to one another between a plurality of coupled arrangements. In accordance with one example, the first component and the second component may be coupled to one another, such that the first component and the second component may rotate relative to one another between a first coupled arrangement in which the coupling ring may be removed from the cavity and a second coupled arrangement in which the coupling ring is locked within the cavity, and thus cannot be withdrawn from the cavity.

In accordance with an aspect of the present disclosure, an anchoring device or system according to the present disclosure may be configurable in multiple coupled arrangements. The multiple coupled arrangements may provide versatility, for example, allowing an object to be coupled to a wall with varying degrees of connectivity, requiring different operations or a varying number of operations to remove or decouple the object from the wall. In accordance with some examples of the present disclosure, changing a coupled arrangement of the anchoring system or device to a specific coupled arrangement may be required to remove or decouple an object from a wall.

In accordance with some examples, an anchoring device or system in accordance with the present disclosure may allow an object, for example, a mirror to be coupled to wall in either of a first arrangement in which the mirror may be removed from the wall when a force exceeding a predetermined threshold is applied to the mirror or a second arrangement in which the mirror cannot be removed from the wall, without first changing a coupled arrangement of the anchoring device or system to the first coupled arrangement.

In accordance with some examples of the present disclosure, a tool may be required to change a coupled state of the anchoring device or system. For example, only a small space may be provided between a wall and an object coupled to the wall and thus a (e.g., narrow, low profile) tool may be required to access the anchoring device or system and to change a coupled arrangement of the anchoring device or system.

Accordingly, an anchoring device or system according to the present disclosure may advantageously decrease the likelihood of a member of the public removing or decoupling an object, for example, a mirror, from a wall in a public or commercial setting, for example, a hotel room, as a tool may be required to change a coupled arrangement of the anchoring device or system and thus to remove or decouple the mirror from the wall. In another example, an anchoring device or system according to the present disclosure may advantageously decrease the likelihood of a member of the public removing or decoupling a bathroom fixture from a wall in a public restroom by requiring a tool to change a coupled arrangement of the anchoring device or system, and thus, to remove or decouple the bathroom fixture from the wall.

In accordance with another aspect of the present disclosure, an anchoring device or system according to the present disclosure may be low profile, such that an object, for example, a mirror, may be coupled to a wall while being offset a minimal or relatively small distance from the wall.

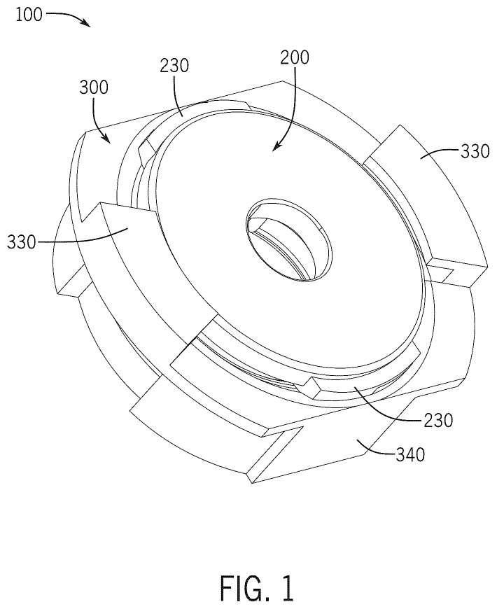

Referring to FIG. 1, an anchoring device 100 is illustrated in accordance with one example of the present disclosure. The anchoring device 100 may be configured to couple two objects to one another. In some examples, the anchoring device 100 may be configured to couple an object to a wall. For example, as noted above, the anchoring device 100 may be configured to couple any of a mirror, a bathroom fixture (e.g., soap dispenser, paper towel dispenser, hand dryer, toilet paper dispenser, towel rack, or the like), a shelf, a cabinet (e.g., medicine cabinet, kitchen cabinet), a cupboard, a light fixture, a portrait or artwork (including a frame or other enclosing structure) or the like to a wall.

As shown in FIG. 1, the anchoring device 100 may include a first component 200 (e.g., first interlocking component, male portion, insert) and a second component 300 (e.g., second interlocking component, female portion, receiver, receptacle). According to the present disclosure, one of the first component 200 and the second component 300 may be attached or coupled to a first object, and the other of the first component 200 and the second component 300 may be coupled to a second object and the first and second objects may be coupled to one another by coupling the first component 200 and the second component 300 to one another. Specifically, according to some examples, one of the first component 200 and the second component 300 may be coupled to a wall and the other of the first component 200 and the second component 300 may be coupled to the object to be coupled or mounted to the wall; the object may then be coupled to the wall by coupling the first component 200 and the second component 300 to one another.

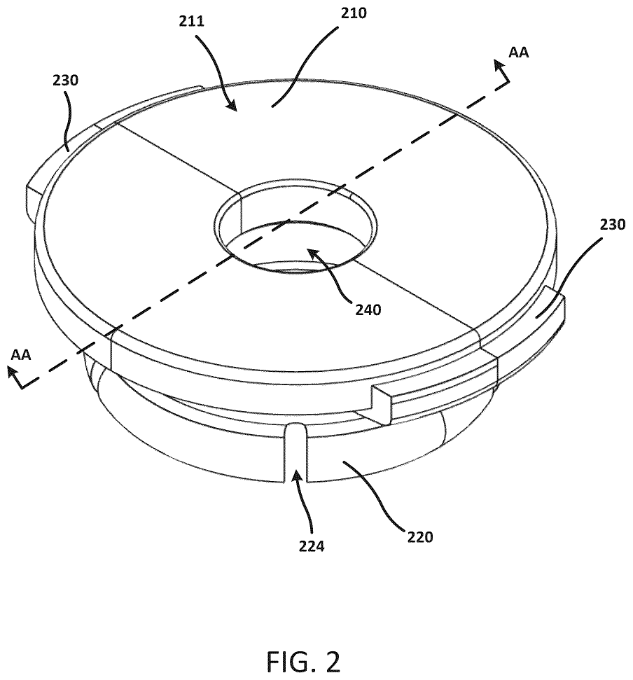

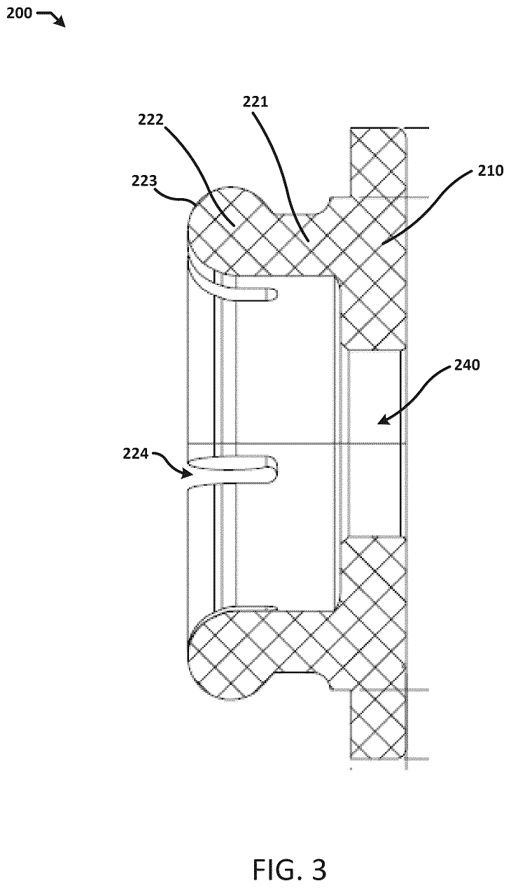

Referring generally to FIGS. 2 and 3, a first component 200 (e.g., first interlocking component, male portion, insert) of the anchoring device 100 is illustrated in accordance with one example of the present disclosure. Referring to FIG. 2, a perspective view of the first component 200 of the anchoring device 100 of FIG. 1 is illustrated in accordance with an example of the present disclosure. Referring to FIG. 3, a cross-sectional view of the first component 200 taken along section line A-A of FIG. 2 is illustrated in accordance with one example of the present disclosure.

As best shown in FIG. 2, the first component 200 may include a body 210, a ring 220 (e.g., coupling ring) extending from the body 210, at least one flange 230 extending from the body 210, and a hole 240 (e.g., body hole) extending through the body 210. In some examples, the first component 200 may be comprised of a plastic or plastics, for example, the first component 200 may be comprised of polypropylene (PP), polyethylene, polycarbonate, or other similar materials. In some examples, the first component 200 may be comprised of acrylonitrile butadiene styrene (ABS).

The body 210 of the first component 200 may be configured to be coupled to one of two objects to be coupled to one another by the anchoring device 100. For example, the body 210 may be coupled to one of a wall and an object to be mounted to the wall. The body 210 (and thus the first component 200) may be removably or permanently coupled, attached, or fixed to one of two objects to be coupled to one another. In some examples, as shown in FIG. 2, the first component 200 may include a hole 240 (e.g., body hole) extending through the body 210. The hole 240 may be configured to receive a body fastener or fastener (e.g., a screw, a nail, a bolt, a rivet, or the like) for coupling, attaching, or fixing the body 210 to one of the two objects to be coupled by the anchoring device 100. In some examples, a threaded fastener (e.g., screw, bolt, or the like) may be used to couple, attach, or fix the body 210 to one of the two objects to be coupled by the anchoring device 100.

In some examples, as shown in FIG. 2, the body 210 may have a cylindrical or disk shape; however, the present disclosure is not limited thereto, and other shapes are possible. In some examples, the body 210 may include a planar surface 211 (e.g., planar body surface). The planar surface 211 of the body 210 may be configured to abut a surface, for example, a planar surface, of one of the two objects to be coupled by the anchoring device 100 when the body 210 is coupled, fixed, or attached to one of the objects to be coupled.

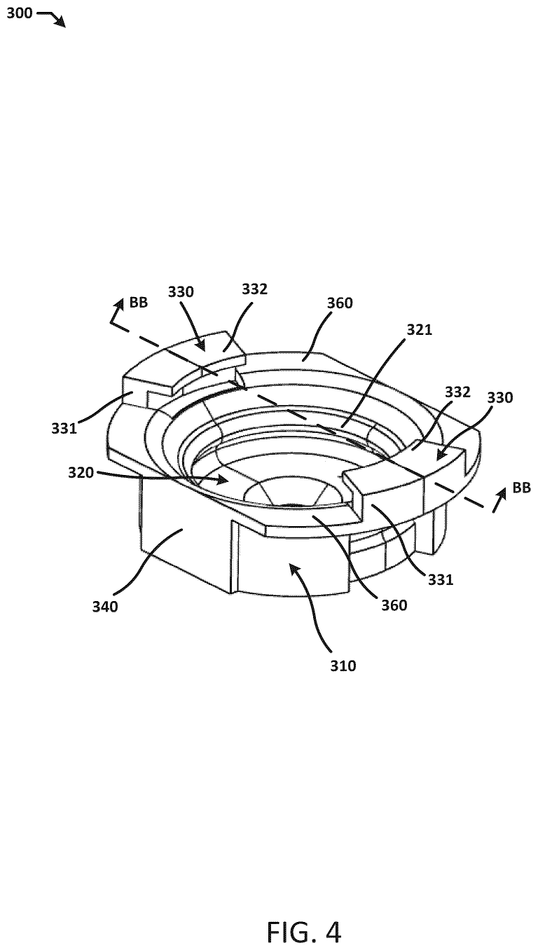

As shown in FIGS. 2 and 3, the first component 200 may further include a ring 220 (e.g., coupling ring) extending from the body 210. According to some examples, the ring 220 may extend from the body 210 in an axial direction. The axial direction may correspond to a direction along which the ring 220 of the first component 200 is inserted into the cavity 320 (see FIG. 4) of the second component 300. Additionally, the first component 200 and the second component 300 may rotate relative to one another about the same axis along which the ring 220 extends from the body 210. According to some examples, the ring 220 may extend from a surface of the body 210 opposite the planar surface 211 of the body 210.

The ring 220 may be configured to be inserted into the cavity 320 (see FIG. 4) of the second component 300, coupling the first component 200 and the second component 300 to one another. For example, the ring 220 and the cavity 320 may have an interference fit connection, such as a press fit, friction fit, or snap fit connection. Accordingly, the ring 220 may be press fit, friction fit, or snap fit into the cavity 320 of the second component 300.

As noted above, according to some examples, the ring 220 may be comprised of one or more plastics. In some examples, the ring 220 may be configured to deform (e.g., elastically deform) as the ring 220 is pushed, pressed, or snapped into the cavity 320. In some examples, an elastic force of the ring 220 may cause the ring 220 to engage the cavity, coupling the first component 200 and the second component 300.

In some examples, as shown in FIG. 3, the ring 220 may include an elongate portion 221 and a coupling portion 222. The elongate portion 221 may extend from the body 210 and be disposed between the body 210 and the coupling portion 222. The elongate portion 221 may offset the coupling portion 222 from the body 210. According to some examples, the coupling portion 222 of the ring 220 may be retained within the cavity 320, coupling the first component 200 and the second component 300. In some examples, the coupling portion 222 may include a rounded exterior or peripheral surface 223, facilitating insertion and withdrawal of the ring 220 from the cavity 320.

In some examples, as shown in FIGS. 2 and 3, the ring 220 may further include one or more (e.g., a plurality of) recesses or notches 224. The one or more notches 224 may be disposed in the coupling portion 222 of the ring 220. The one or more notches may facilitate insertion and/or withdrawal of the ring 220 from the cavity 320, by providing space for the ring 220, for example, the coupling portion 222 of the ring 220 to elastically deform into as the ring 220 is inserted and/or withdrawn from the cavity 320.

As shown in FIG. 2, the first component 200 may further include at least one cam or flange 230. The at least one flange 230 may extend from the body 210 in a radial direction. For example, the at least one flange 230 may extend from the body 210 along an axis perpendicular to an axis along which the ring 220 extends from the body 210. As described hereinafter in greater detail, in some coupled arrangements, the at least one flange 230 of the first component 200 engages (e.g., abuts) a retaining feature 330 (see FIG. 4) of the second component 300, preventing the first component 200 from being removed from the second component 300 (and thus preventing the first component 200 and the second component 300 from being decoupled or separated from one another).

In some examples, as shown in FIG. 2, the first component 200 may include a plurality of flanges 230. For example, as shown, the first component 200 may include two (e.g., a pair of) flanges 230; however, the present disclosure is not limited thereto, and any number of flanges may be included. In some examples, as shown in FIG. 2, the first component 200 may include a pair of flanges 230, each of the pair of flanges 230 extending from an opposite side of the body 210.

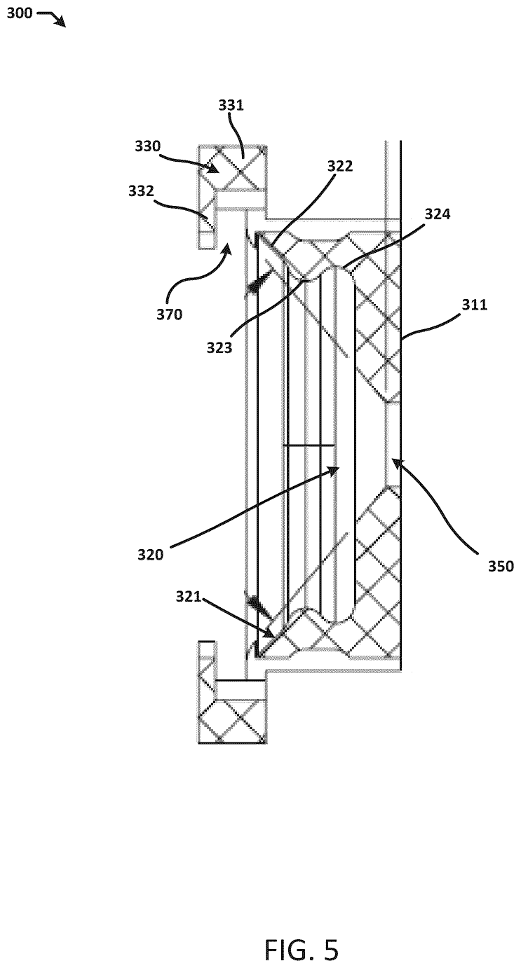

Referring generally to FIGS. 4 and 5, a second component 300 (e.g., second interlocking component, female portion, receiver, receptacle) of the anchoring device 100 is illustrated in accordance with one example of the present disclosure. Referring to FIG. 4, a perspective view of the second component 300 of the anchoring device 100 of FIG. 1 is illustrated in accordance with an example of the present disclosure. Referring to FIG. 5, a cross-sectional view of the second component 300 taken along section line B-B of FIG. 4 is illustrated in accordance with one example of the present disclosure.

As best shown in FIG. 4, the second component 300 may include a base 310 including a cavity 320, at least one retaining feature 330 disposed along the cavity 320, and a pair of flats 340. In some examples, the second component 300 may be comprised of a plastic or plastics, for example, the second component 300 may be comprised of polypropylene (PP), polyethylene, polycarbonate, or other similar materials. In some examples, the second component 300 may be comprised of acrylonitrile butadiene styrene (ABS).

The base 310 of the second component 300 may be configured to be coupled to one of two objects to be coupled to one another by the anchoring device 100. For example, the base 310 may be coupled to one of a wall and an object to be mounted to the wall. According to the present disclosure, the base 310 of the second component 300 and the body 210 of the first component 200 may be coupled to different ones of two objects to be coupled to one another by the anchoring device 100.

The base 310 (and thus the second component 300) may be removably or permanently coupled, attached, or fixed to one of the two objects to be coupled to one another. In some examples, as best shown in FIG. 5, the base 310 may include a hole 350 (e.g., base hole) extending from the base 310. In some examples, as shown in FIG. 5, the hole 350 may extend through the base 310 at a location corresponding to the cavity 320. For example, as shown in FIG. 5, the hole 350 may extend through the base 310 at a location corresponding to a center of the cavity 320. The hole 350 may be configured to receive a base fastener or fastener (e.g., a screw, a nail, a bolt, a rivet, or the like) for coupling, attaching, or fixing the base 310 to one of the two objects to be coupled by the anchoring device 100. In some examples, a threaded fastener (e.g., screw, bolt, or the like) may be used to couple, attach, or fix the base 310 to one of the two objects to be coupled by the anchoring device 100.

As best shown in FIG. 5, in some examples, the base 310 may include a planar surface 311 (e.g., planar base surface). The planar surface 311 of the base 310 may be configured to abut a surface, for example, a planar surface, of one of the two objects to be coupled by the anchoring device 100 when the base 310 is coupled, fixed, or attached the one of the objects to be coupled.

As shown in FIGS. 4 and 5, the second component 300 further comprises a cavity 320 disposed within the base 310. The cavity 320 may be disposed in a side of the base 310 opposite the planar surface 311 of the base 310. The cavity 320 may be configured to receive the ring 220 of the first component 200, coupling the first component 200 and the second component 300. As noted above, the cavity 320 and the ring 220 may have an interference fit connection and the ring 220 may be press fit, friction fit, or snap fit into the cavity 320. In some examples, as shown in FIGS. 4 and 5, an opening of the cavity 320 may have a circular shape, facilitating a rotatable connection between the cavity 320 and the (e.g., round, circular) coupling ring 220. In some examples, as shown in FIG. 4, the base 310 may include a collar 360 disposed along or around the cavity 320.

The cavity 320 may include an interior surface 321 (e.g., cavity interior surface) defining a shape of the cavity 320. In some examples, as best shown in FIG. 5, the interior surface 321 may include a converging portion 322, a protruding portion 323, and a retaining portion 324.

As shown in FIG. 5, the converging portion 322 may be disposed between an opening of the cavity 320 and the protruding portion 323 of the interior surface 321. As shown in FIG. 4, the converging portion 322 of the interior surface 321 may correspond to a converging section of the cavity 320 in which an area of the cavity is gradually reduced from the opening of the cavity to the protruding portion 323 of the interior surface 321.

The protruding portion 323 of the interior surface 321 may be a portion of the interior surface 321 extending toward a center of the cavity 320. According to some examples, the protruding portion 323 may be configured to retain the ring 220, for example, the coupling portion 222 of the ring 220 within a section (e.g., volume) of the cavity 320 corresponding to the retaining portion 324 of the interior surface 321. The protruding portion 323 of the interior surface 321 may correspond to a section of the cavity 320 having a smallest area. The protruding portion 323 may be disposed between the converging portion 322 and the retaining portion 324.

The retaining portion 324 (e.g., diverging portion) of the interior surface 321 may be a portion of the interior surface in which the interior surface 321 of the cavity 320 diverges (e.g., from the protruding portion 323, from a center of the cavity 320). The retaining portion 324 of the interior surface 321 may correspond to a retaining section (e.g., volume) of the cavity 320 configured to receive and retain the ring 220, for example, the coupling portion 222 of the ring.

As shown in FIGS. 4 and 5, the second component 300 may further include at least one retaining feature 330. The at least one retaining feature 330 may be disposed along or adjacent to the cavity 320. The at least one retaining feature 330 may include an extended portion 331 and an overhang 332. The extended portion 331 may extend from the base 310. For example, the extended portion may extend from the base 310 in an axial direction. In some examples, the extended portion may extend from a collar 360 of the base 310. The at least one retaining feature 330 may further include an overhang 332. The overhang 332 may extend from the extended portion 331. In some examples, as shown in FIGS. 4 and 5, the overhang 332 may extend toward a center of the base 310. The overhang 332 may extend from the extended portion 331 along an axis perpendicular to the axis along which the extended portion 331 extends from the base 310.

As shown in FIGS. 4 and 5, the overhang 332 may be offset from the base 310 and/or the cavity 320, such that a slot 370 is disposed between the base 310 and the overhang 332. The slot 370 may be configured to receive a flange 230 of the first component 200 in some coupled arrangements of the first component 200 and the second component 300. As described hereinafter in greater detail, in some coupled arrangements, the at least one flange 230 of the first component 200 may be disposed within the slot 370 and the overhang 332 of the second component 300 may engage (e.g., abut) the flange 230 of the first component 200, preventing the first component 200 from being removed from the second component 300 (and thus preventing the first component 200 and the second component 300 from being decoupled or separated from one another).

In some examples, as shown in FIGS. 4 and 5, the second component 300 may include a plurality of retaining features. For example, as shown, the second component 300 may include two (e.g., a pair of) retaining features 330; however, the present disclosure is not limited thereto, and any number of retaining features 330 may be included. Each retaining featured may include an extended portion 331 and an overhang 332. In some examples, as shown in FIGS. 4 and 5, the second component 300 may include a pair of retaining features 330, each of the pair of retaining features 330 may be disposed (e.g., extend from the base 310) on an opposite side of the cavity 320.

As shown in FIG. 4, the second component 300 may further include a pair of flats 340. Each of the pair of flats 340 may be a planar (e.g., flat) surface disposed on a side of the base 310. In some examples, the pair of flats 340 may be disposed on opposite sides of the base 310. As described hereinafter in greater detail, each of the pair of flats 340 may be configured to be engaged by a tool (e.g., locking tool) for rotating the second component 300.

Returning to FIG. 1, the anchoring device 100 is illustrated in a coupled arrangement in which the first component 200 is (e.g., at least partially) disposed within the second component 300. Specifically, FIG. 1 illustrates the anchoring device 100 in a coupled arrangement in which the ring 220 of the first component 200 is disposed within the cavity 320 of the second component 300. The first component 200 and the second component 300 may be rotatably coupled to one another as shown in FIG. 1. Specifically, the first component 200 and the second component 300 may be free to rotate relative to one another when the ring 220 of the first component 200 is disposed within the cavity 320 of the second component 300.

According to the present disclosure, the anchoring device 100 may couple two objects to one another in a plurality of coupled arrangements. Each coupled arrangement of two objects coupled to one another may correspond to a coupled arrangement of the first component 200 and the second component 300. The first component 200 and the second component 300 may be coupled to one another in a plurality of coupled arrangements. The ring 220 of the first component 200 may be disposed within the cavity 320 of the second component 300 in each of the plurality of coupled arrangements. According to the present disclosure, a relative position of the first component 200 and the second component 300 to one another may control or dictate a coupled arrangement of the first component 200 and the second component 300. According to the present disclosure, the first component 200 and the second component 300 may rotate relative to one another between the various coupled arrangements.

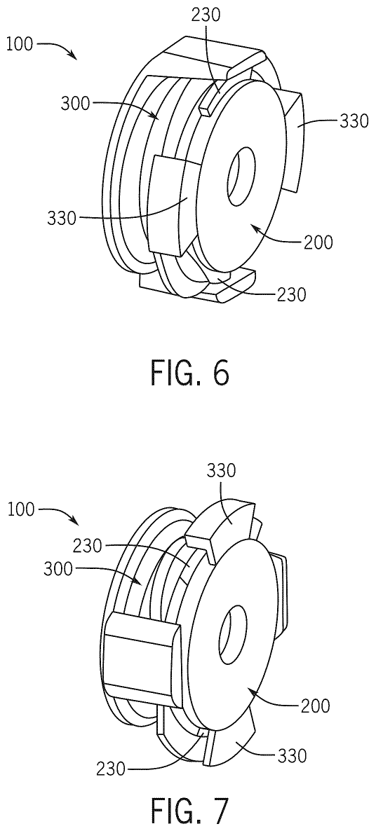

Referring to FIG. 6, an anchoring device 100 is illustrated in a first coupled arrangement in accordance with one example of the present disclosure. As shown in FIG. 6, the first component 200 and the second component 300 may be coupled to one another in the first coupled arrangement. For example, as shown in FIG. 6, the ring 220 of the first component 200 may be disposed within the cavity 320 of the second component 300 in the first coupled arrangement.

According to some examples, the first coupled arrangement of the anchoring device 100 may be one in which the ring 220 may (e.g., is configured to) be withdrawn from the cavity 320 of the second component 300. For example, as shown in FIG. 6, in the first coupled arrangement, the at least one flange 230 of the first component 200 may be misaligned or offset from the at least one retaining feature 330 of the second component 300. Accordingly, in the first coupled arrangement, the first component 200 may be withdrawn from the second component 300 without the at least one flange 230 and the at least one retaining feature 330 interfering with (e.g., engaging, contacting) one another.

According to the present disclosure, when the anchoring device 100 is in the first coupled arrangement, a separating force exceeding a predetermined threshold may be required to withdraw the first component 200 from the second component 300. For example, the predetermined threshold may correspond to an amount of force required to deform the ring 220 (e.g., the coupling portion 222) and/or the interior surface 321 of the cavity 320, such that the ring 220 may be withdrawn from the cavity 320 (e.g., past the protruding section). The separating force may be, for example, a pulling force applied to one of the first component 200 and the second component 300 away from the other of the first component 200 and the second component 300 in an axial direction. An axial direction may be a direction along an axis about which the first component 200 or second component 300 translates such that the ring 220 is inserted to or withdrawn from the cavity 320. An axial direction may be a direction about which the first component 200 and the second component 300 rotate relative to one another when the first component 200 and the second component 300 are coupled to one another.

In some examples, as shown in FIG. 6, when the first portion 200 includes a plurality of flanges 230 and the second component 300 includes a plurality of retaining features 330, the first coupled arrangement of the anchoring device 100 may be one in which none of the plurality of flanges 230 align with any of the plurality of retaining features 330.

Referring to FIG. 7, an anchoring device 100 is illustrated in a second coupled arrangement in accordance with one example of the present disclosure. As shown in FIG. 7, the first component 200 and the second component 300 may be coupled to one another in the second coupled arrangement. For example, as shown in FIG. 7, the ring 220 of the first component 200 may be disposed within the cavity 320 of the second component 300 in the second coupled arrangement.

According to some examples of the present disclosure, when the anchoring device 100 is in the second coupled arrangement, the first component 200 (e.g., the ring 220) may be locked within the second component 300 (e.g., the cavity 320, the retaining section), such that the first component 200 is prevented from being withdrawn from the second component 300.

For example, as shown in FIG. 7, the second coupled arrangement may be one in which the at least one flange 230 of the first component 200 aligns with a retaining feature 330 of the second component 300. Accordingly, when a separating force is applied to one of the first component 200 and the second component 300 when the anchoring device 100 is in the second coupled arrangement, the at least one flange 230 of the first component may engage (e.g., abut, contact) a retaining feature 330 of the second component 300, preventing the first component 200 from being withdrawn from the second component 300. For example, the retaining feature 330 may interfere with the at least one flange 230, contacting the flange 230 and preventing the first component 200 from being moved to a position in which the ring 220 of the first component 200 is withdrawn from or outside of the cavity 320 of the second component 300.

According to some examples of the present disclosure, as shown in FIG. 7, the at least one flange 230 of the first component 200 and the at least one retaining feature 330 of the second component 300 may be provided in a corresponding number. For example, as shown in FIG. 7, the first component 200 may include two flanges 230 and the second component 300 may include two retaining features 330; however, the present disclosure is not limited thereto and any number of flanges 230 and retaining features 330 may be provided. For example, the anchoring device 100 may include a single flange 230 and a single retaining feature 330, three flanges 230 and three retaining features 330, four flanges 230 and four retaining features 330, or a corresponding number of more than four flanges and retaining features 330.

According to some examples, as shown in FIG. 7, when the first component 200 includes two or more flanges 230 and the second component includes a corresponding number of two or more retaining features 330, the second coupled arrangement of the anchoring device 100 may be one in which each flange 230 aligns with a corresponding retaining feature 330. For example, the two or more flanges 230 of the first component 200 maybe offset from one another the same circumferential distance as the two or more retaining features 330 of the second component 300 are offset from one another.

In some examples, when an anchoring device 100 in accordance with an example of the present disclosure is in the second coupled arrangement, the coupled arrangement of the anchoring device 100 must first be moved to the first coupled arrangement before the first component 200 may be removed from the second component 300. After being moved from the second coupled arrangement to the first coupled arrangement, the first component 200 may be removed from the second component 300 when a separating force exceeding a predetermined threshold is applied to one of the first component 200 and the second component 300 as described above with respect to FIG. 6.

Accordingly, when the anchoring device 100 is disposed in the second coupled arrangement an additional rotational manipulation of at least one of the first component 200 and/or the second component 300 is required before withdrawing the first component 200 from the second component 300 as described above with respect to FIG. 6.

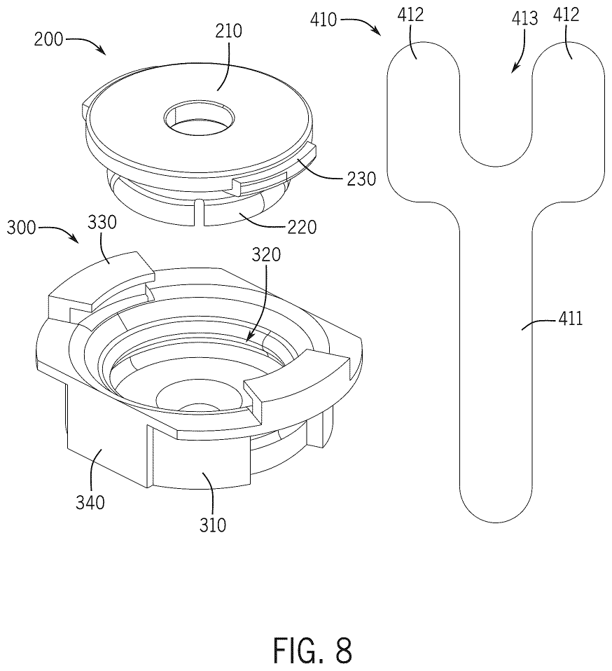

Referring to FIG. 8, an anchoring system 400 is illustrated in accordance with one example of the present disclosure. As shown in FIG. 8, the anchoring system 400 may include an anchoring device 100 and a locking tool 410. The anchoring device 100 may include a first component 200 (e.g., first interlocking component, male portion, insert) and a second component 300 (e.g., second interlocking component, female portion, receiver, receptacle) and be the same as the anchoring device 100 described above with respect to FIGS. 1-7.

As shown in FIG. 8, the anchoring system 400 may include a locking tool 410. The locking tool 410 may include a handle 411, a pair of jaws 412, and a mouth 413 disposed between the pair of jaws 412. According to the present disclosure, the handle 411 may have an elongate shape configured to be held by a user. Each of the pair of jaws 412 may extend from the handle 411 of the locking tool 410. In some examples, as shown in FIG. 8, the pair of jaws 412 may be spaced apart from one another. In some examples, as shown in FIG. 8, the pair of jaws 412 may be parallel to one another. However, the present disclosure is not limited thereto, and in other examples the pair of jaws 412 may be disposed at an (e.g., oblique) angle with respect to one another.

The locking tool 410 may be configured to engage the anchoring device. For example, the locking tool 410 may be configured to engage the second component 300 and to rotate the second component 300 relative to the first component 200, for example, changing a coupled arrangement of the anchoring device 100. Specifically, each of the pair of jaws 412 of the locking tool 410 may be configured to engage (e.g., abut, contact) a respective one of the pair of flats 340 of the second component 300.

The locking tool 410 may be configured to rotate the second component 300 relative to the first component 200 and/or an object to which the second component is coupled. For example, the mouth 413 of the locking tool 410 may be provided around the base 310 of the second component 300 such that each of the jaws 412 of the locking tool engages a flat 340 of the second component 300. The second component 300 may then be rotated by a user holding the handle 411 of the locking tool 410. Accordingly, the locking tool 410 may be configured to rotate the second component 300 relative to the first component so as to changing a coupled arrangement of the anchoring device.

According to some examples of the present disclosure, the locking tool 410 may be relatively thin, such that the locking tool 410 may be inserted into a narrow space between a surface and an object mounted to the surface, so as to access an anchoring device 100 disposed between the surface and the object for changing a coupled arrangement of the anchoring device 100. For example, the locking tool may have a thickness of less than three quarters of an inch, less than half an inch, or less than a quarter of an inch.

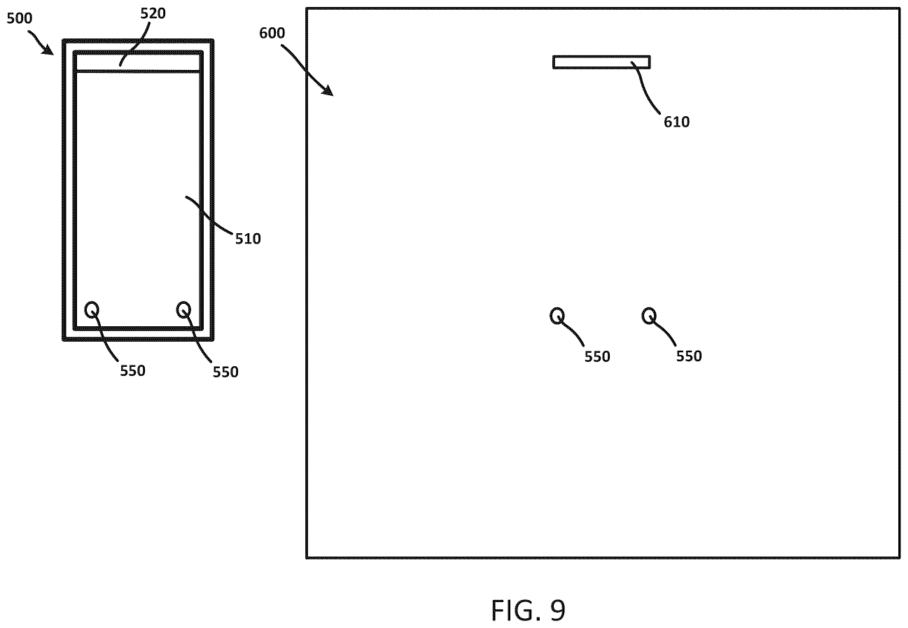

Referring to FIG. 9, a mirror 500, a wall 600, and a plurality of anchoring devices 100 are illustrated in accordance with one example of the present disclosure. According to some examples, one or more anchoring devices 100 or an anchoring system 400 in accordance with the present disclosure may be used to couple a mirror 500 to a wall 600. Specifically, referring to FIG. 9, a back side 510 of a mirror is illustrated. As shown, the mirror 500 may include a catch 520 offset from a back side 510 of the mirror 500. The catch 520 may be disposed proximate to a top of the mirror 500 as shown in FIG. 9. As shown in FIG. 9, one or more interlocking components 550 may be coupled, attached, or fixed to the back side 510 of the mirror 500. Each interlocking component 550 may be one of a first component 200 or a second component 300 as described herein.

As shown in FIG. 9, a cleat 610 and one or more interlocking components 550 may be coupled to the wall 600. In some examples, the cleat 610 may extend or protrude from the wall 600. According to some examples, of the present disclosure the mirror 500 may be coupled to the wall 600 by providing the catch 520 coupled to the back side 510 of the mirror 500 over the cleat 610 coupled the wall 600. According to some examples, the catch 520 and the cleat 610 may secure a top portion or side of the mirror 500 to the wall 600. In some examples, after providing the catch 520 over the cleat 610 one or more of the interlocking components 550 coupled to the mirror 500 may be coupled to one or more interlocking component 550 coupled to the wall 600, coupling the mirror 500 to the wall 600. According to other examples, the cleat 610 may be coupled to the back side 510 of the mirror 500 and the catch 520 may be coupled to the wall 600.

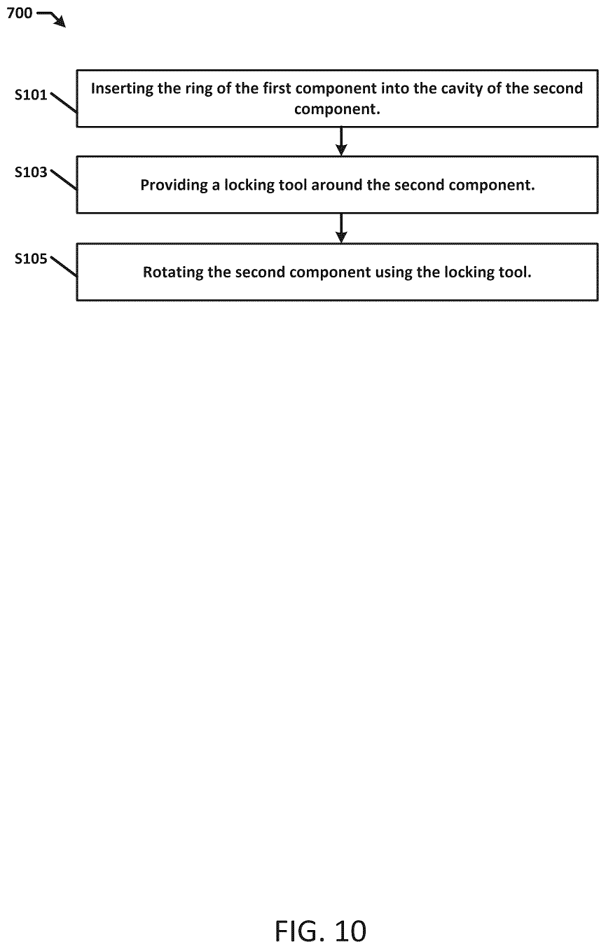

Referring to FIG. 10, a flow chart 700 for anchoring an object to a surface is illustrated in accordance with one example of the present disclosure. The flow chart 700 may be used with both an anchoring device 100 and an anchoring system 400 as described herein. Additional, different, or fewer acts may be provided.

In a first act S101, the ring 220 of a first component 200 may be inserted into the cavity 320 of the second component 300. For example, an axial force may be applied to one of the first component 200 and/or the second component 300, such that the ring 220 of the first component 200 moves into the cavity 320 of the second component 300, coupling the first component 200 and the second component 300. As described above, in some examples, the ring 220 may be press fit or snap fit into the cavity 320. According to some examples of the present disclosure, after the ring 220 is inserted into the cavity 320, the anchoring device 100 may be in a first coupled arrangement. Specifically, the anchoring device 100 may be disposed in a first arrangement because in some examples, it may not be possible to insert the first component 200 into the second component 300 when a flange 230 of the first component 200 is aligned with a retaining feature 330 of the second component 300.

In a second act S103, a locking tool 410 may be provided around the second component 300. Specifically, as described above, the mouth 413 of the locking tool 410 may be provided around the base 310 of the second component 300, such that each one of the pair of jaws 412 engages (e.g., contacts) a respective one of the pair of flats 340 of the second component 300. According to some examples, as described above, providing the locking tool 410 around the second component 300 may include inserting the locking tool 410 in a narrow opening between a surface and an object coupled to the surface, so as to access the anchoring device 100 and change a coupled arrangement of the anchoring device 100.

In a third act S103, the second component 300 may be rotated using the locking tool 410. For example, a user may move or manipulate the handle 411 of the locking tool 410, such that the locking tool 410 rotates the second component 300. According to some examples, the second component 300 may rotate relative to the first component 200 such that a coupled arrangement of the anchoring device is changed from the first coupled arrangement to the second coupled arrangement and thus the first component 200 is locked within the second component 300. Specifically, the second component 300 may be rotated such that the at least one flange 230 of the first component 200 is aligned with a retaining feature 330 of the second component 300.

When a component, device, element, or the like of the present disclosure is described as having a purpose or performing an operation, function, or the like, the component, device, or element should be considered herein as being “configured to” meet that purpose or to perform that operation or function.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An anchoring device comprising:
an insert including a body and a coupling ring extending axially from the body; and
a receptacle including a base having a cavity, the cavity configured to receive the coupling ring, coupling the insert and the receptacle,
wherein the insert and the receptacle are configured to rotate relative to one another between a first coupled arrangement in which the coupling ring is configured to be withdrawn from the cavity and a second coupled arrangement in which the coupling ring is locked within the cavity.

2. The anchoring device of claim 1, wherein the insert further comprises at least one flange extending radially from the body and the receptacle further comprises at least one retaining feature disposed along the cavity.

3. The anchoring device of claim 2, wherein in the first coupled arrangement the at least one flange and the at least one retaining feature are offset, and
wherein in the second coupled arrangement the at least one flange and the at least one retaining feature are aligned such that the at least one retaining feature engages the at least one flange preventing the coupling ring from being withdrawn from the cavity.

4. The anchoring device of claim 2, wherein the at least one flange and the at least one retaining feature are provided in a corresponding number.

5. The anchoring device of claim 1, wherein in the first coupled arrangement the coupling ring is configured to be withdrawn from the cavity when a separating force exceeding a predetermined threshold is applied to the insert or the receptacle.

6. The anchoring device of claim 1, wherein the body includes a hole extending therethrough configured to receive a fastener for coupling the insert to a mounting surface or an object to be mounted.

7. The anchoring device of claim 1, wherein the base includes a hole extending therethrough configured to receive a fastener for coupling the receptacle to a mounting surface or an object to be mounted.

8. The anchoring device of claim 1, wherein the receptacle is rotatably coupled to a mounting surface or an object to be mounted and further comprises a pair of flats disposed on an opposite sides of the base, the pair of flats configured to be engaged by a locking tool configured to rotate the base.

9. A method for anchoring an object to a surface using an anchoring device including an insert and a receptacle, the insert including a body, a coupling ring extending axially from the body, and at least one flange extending from the body, the receptacle including a base having a cavity, at least one retaining feature disposed along the cavity, and a pair of flats disposed on opposite sides of the base, the method comprising:
inserting the coupling ring into the cavity, coupling the insert and the receptacle;
providing a locking tool around the receptacle such that the locking tool engages the pair of flats; and
rotating the receptacle using the locking tool, changing an arrangement of the insert and the receptacle from a first coupled arrangement in which the at least one flange and the at least one retaining feature are offset to a second coupled arrangement in which the at least one flange and the at least one retaining feature are aligned.

10. The method of claim 9, wherein in the first coupled arrangement the coupling ring is configured to be withdrawn from the cavity when a separating force exceeding a predetermined threshold is applied to the insert or the receptacle.

11. The method of claim 9, wherein in the second coupled arrangement, the at least one retaining feature engages the at least one flange preventing the coupling ring from being withdrawn from the cavity.

12. The method of claim 9, further comprising:
inserting a fastener through a hole extending through the body; and
coupling the insert to the surface or the object using the fastener.

13. The method of claim 9, further comprising:
inserting a fastener through a hole extending through the base; and
coupling the receptacle to the surface or the object using the fastener.

14. The method of claim 9, wherein the object is a mirror and the insert or the receptacle is coupled to the mirror.

15. A system for anchoring an object to a surface, the system comprising:
a first component including a body configured to be coupled to the object or the surface and a coupling ring extending from the body; and
a second component including a base configured to be coupled to the object or the surface, the base including a cavity configured to receive the coupling ring, coupling the first component and the second component,
wherein the first component and the second component are configured to rotate relative to on another between a first coupled arrangement in which the coupling ring is configured to be withdrawn from the cavity and a second couped arrangement in which the coupling ring is locked within the cavity.

16. The system of claim 15, wherein the second component includes a pair of flats disposed on opposite sides of the base, the system further comprising:
a locking tool configured to engage the pair of flats to rotate the second component relative to the first component.

17. The system of claim 15, wherein the first component further comprises at least one flange extending radially from the body and the second component further comprises at least one retaining feature disposed along the cavity.

18. The system of claim 17, wherein in the first coupled arrangement the at least one flange and the at least one retaining feature are offset, and
wherein in the second coupled arrangement the at least one flange and the at least one retaining feature are aligned such that the at least one retaining feature engages the at least one flange preventing the coupling ring from being withdrawn from the cavity.

19. The system of claim 17, wherein in the first coupled arrangement the coupling ring is configured to be withdrawn from the cavity when a separating force exceeding a predetermined threshold is applied to the first component or the second component.

20. The system of claim 17, wherein the at least one flange comprises two flanges and the at least one retaining feature comprises two retaining features.
